(19) United States
(12) Patent Application Publication
(10) Pub. No.: US 2026/0336423 A1
(43) Pub. Date: Oct. 29, 2026

(54) DC LINK CAPACITOR DISCHARGE BASED ON ENERGY TRANSFER

(71) Applicant: SEMICONDUCTOR COMPONENTS INDUSTRIES, LLC, Scottsdale, AZ (US)

(72) Inventors: Jeevan THOMAS, Bangalore (IN); Milind DIGHRASKER, Bangalore (IN)

(73) Assignee: SEMICONDUCTOR COMPONENTS INDUSTRIES, LLC, Scottsdale, AZ (US)

(21) Appl. No.: 19/444,671

(22) Filed: Jan. 9, 2026

Related U.S. Application Data
(60) Provisional application No. 63/793,967, filed on Apr. 24, 2025.

(51) Int. Cl. B60L 15/00; H02M 7/483; H02M 7/5395; B60L 3/04

(52) U.S. Cl. CPC B60L 15/007; H02M 7/483; H02M 7/5395; B60L 3/04

(57) ABSTRACT

A motor drive system is disclosed. The motor drive system includes a DC link capacitor coupled to a DC voltage bus, a motor, and an inverter coupled to the DC voltage bus and including a first phase coupled to a first winding of the motor, a second phase coupled to a second winding of the motor, and a third phase coupled to the third winding of the motor. The motor drive system further includes a control circuit configured to drive a high-side switch of the first phase of the inverter with a high-side PWM signal and drive a low-side switch of the second phase of the inverter in an on-state for a transfer period, and to drive the high-side switch of the first phase in an off-state and drive the low-side switch of the second phase in an on-state for a discharge period subsequent to the transfer period.

### PRIORITY

This application claims the benefit of provisional patent application No. 63/793,967, filed Apr. 24, 2025, which is hereby incorporated by reference herein in its entirety.

### TECHNICAL FIELD

The disclosure relates generally to inverter systems, and particularly to the discharge of a DC link capacitor in an inverter system.

### BACKGROUND

In electric vehicles, a three-phase inverter system may drive an electric motor to provide the primary motive force of the vehicle. The inverter system may be powered by a high-voltage battery, operating for example at 400 V or 800 V. The inverter system typically employs a large energy storage capacitor, referred to as a DC link capacitor, to maintain a desired bus voltage and to smooth any switching related ripples on the bus line.

A shutdown of the drive system may be initiated by various events, such as a detected crash or a simple turning off of the vehicle. During the shutdown, the high-voltage battery may be isolated from the remainder of the inverter system for safety purposes. However, the DC link capacitor may remain charged at the high voltage. Various safety requirements specify that the high-voltage charge stored on the DC link capacitor must be discharged within a specified time. For example, Federal Motor Vehicle Safety Standards (FMVSS) in the United States require that the voltage on the DC link capacitor must, under certain circumstances, be discharged to less than 60 V within 5 seconds of the shutdown.

Some conventional inverter systems have employed a discharge path through a high-voltage rated transistor coupled in series with high-wattage resistors. Inventors of embodiments of the present disclosure have recognized that such high-voltage rated transistors and high-wattage resistors may be bulky, require thermal management, and add to the cost of manufacturing the system. Other conventional inverter systems have employed a discharge path directly through high-voltage and high-power rated transistors, creating a high-current short-circuit path for a short duration. However, inventors of embodiments of the present disclosure have also recognized that high currents through such discharge transistors may degrade the life of the discharge transistors as this discharge operation is repeated on a regular basis. Embodiments of the present disclosure may address one or more of these challenges.

### SUMMARY

The examples herein enable a motor drive system configured to utilize energy transfer to discharge a DC link capacitor.

According to one embodiment, a motor drive system includes (i) a DC link capacitor coupled to a DC voltage bus, (ii) a motor including a first winding, a second winding, and third winding, (iii) an inverter coupled to the DC voltage bus and including a first phase coupled to the first winding of the motor, a second phase coupled to the second winding of the motor, and a third phase coupled to the third winding of the motor, and (iv) a control circuit coupled to control the inverter, wherein the control circuit is configured to drive a high-side switch of the first phase of the inverter with a high-side PWM signal and drive a low-side switch of the second phase of the inverter in an on-state for a transfer period, and subsequent to the transfer period, drive the high-side switch of the first phase in an off-state and drive the low-side switch of the second phase in an on-state for a discharge period. In some embodiments, the control circuit is configured to transition from the transfer period to the discharge period in response to a monitor circuit detecting that a voltage of the DC link capacitor has crossed below a voltage threshold. In other embodiments, the control circuit is configured to transition from the transfer period to the discharge period in response to expiration of a predetermined time for the transfer period. In the same of different embodiments, the high-side PWM signal has a fixed pulse width. In the same or different embodiments, the control circuit is further configured to drive a low-side switch of the first phase of the inverter with a low-side PWM signal that is the inverse of the high-side PWM signal during the transfer period. In the same or different embodiments, the control circuit is further configured to drive a low-side switch of a third phase of the inverter in an on-state during the transfer period and during the discharge period. In the same or different embodiments, the high-side PWM signal and a duration of the transfer period are configured such that a peak current through any winding of the motor is insufficient for inducing motive force.

According to another embodiment, a control circuit for a motor drive system includes an input configured to receive a discharge command, and a plurality of outputs configured to control switching of an inverter that is to be powered by a DC voltage bus and coupled to a motor, wherein the control circuit is configured to, in response to the discharge command, drive a high-side switch of a first phase of the inverter with a high-side PWM signal and drive a low-side switch of a second phase of the inverter in an on-state for a transfer period, and subsequent to the transfer period, drive the high-side switch of the first phase in an off-state and drive the low-side switch of the second phase in an on-state for a discharge period. In some embodiments, the control circuit is configured to transition from the transfer period to the discharge period in response to a monitor circuit detecting that the DC voltage bus has crossed below a voltage threshold. In other embodiments, the control circuit is configured to transition from the transfer period to the discharge period in response to expiration of a predetermined time for the transfer period. In the same of different embodiments, the high-side PWM signal has a fixed pulse width. In the same or different embodiments, the control circuit is further configured to drive a low-side switch of the first phase of the inverter with a low-side PWM signal that is the inverse of the high-side PWM signal during the transfer period. In the same or different embodiments, the control circuit is further configured to drive a low-side switch of a third phase of the inverter in an on-state during the transfer period and during the discharge period. In the same or different embodiments, the high-side PWM signal and a duration of the transfer period are configured such that a peak current through any winding of the motor is insufficient for inducing motive force.

Another embodiment provides a method for controlling operation of a motor drive system, wherein the method includes (i) transferring energy from the DC link capacitor to windings of an motor during a transfer period by driving a high-side switch of a first phase of an inverter coupled to the motor with a high-side PWM signal and driving a low-side switch of a second phase of the inverter in an on-state, and (ii) discharging energy from the windings of the motor during a discharge period subsequent to the transfer period by driving the high-side switch of the first phase in an off-state and driving the low-side switch of the second phase in an on-state. In some embodiments, the method further comprises transitioning from the transfer period to the discharge period in response to detecting that a voltage of the DC link capacitor has crossed below a voltage threshold. In other embodiments, the method further comprises transitioning from the transfer period to the discharge period in response to expiration of a predetermined time for the transfer period. In the same or different embodiments, the high-side PWM signal has a fixed pulse width. In the same or different embodiments, the method further comprises driving a low-side switch of the first phase of the inverter with a low-side PWM signal that is the inverse of the high-side PWM signal during the transfer period. In the same or different embodiments, the method further comprises driving a low-side switch of a third phase of the inverter in an on-state during the transfer period and during the discharge period. In the same or different embodiments, a peak current through the windings of the motor during the transfer period remains below a current threshold for inducing motive force.

### BRIEF DESCRIPTION OF THE DRAWINGS

A more complete understanding of the present embodiments may be acquired by referring to the following description taken in conjunction with the accompanying drawings, in which like reference numbers indicate like features.

FIG. 1 illustrates a schematic diagram of a motor drive system in accordance with embodiments of the present disclosure.

FIG. 2 illustrates plot diagrams of waveforms within a motor drive system in accordance with embodiments of the present disclosure.

FIG. 3 illustrates a schematic diagram of a motor drive system in accordance with embodiments of the present disclosure.

FIG. 4 illustrates plot diagrams of waveforms within a motor drive system in accordance with embodiments of the present disclosure.

FIG. 5 illustrates a method for controlling operation of a motor drive system in accordance with embodiments of the present disclosure.

### DETAILED DESCRIPTION

Details of one or more embodiments are set forth in the description below and the accompanying drawings. Other features will be apparent from the description, drawings, and from the claims. The embodiments disclosed should not be interpreted, or otherwise used, as limiting the scope of the disclosure, including the claims. In addition, one skilled in the art understands that the following description has broad application, and the discussion of any embodiment is meant to be exemplary of that embodiment, and not intended to intimate that the scope of the disclosure, including the claims, is limited to that embodiment.

Various terms are used to refer to particular system components. Different companies may refer to a component by different names, and this disclosure does not intend to distinguish between components that differ in name but not form and function. In the following discussion and in the claims, the terms “including” and “comprising” are used in an open-ended fashion, and thus should be interpreted to mean “including, but not limited to.” Also, the term “couple” or “coupled” is intended to encompass either an indirect connection or a direct connection. Thus, if a first device couples to, or is coupled to, a second device, that connection between the first device and the second device may be through a direct connection or through an indirect connection via other devices and connections.

Further, although the terms “first,” “second,” and so forth may be used herein to describe various elements, these elements should not be limited by these terms. Terms such as “first” and “second” may be used merely to distinguish one element from another. For example, a first element could be termed a second element, and, similarly, a second element could be termed a first element, without departing from the scope of the present disclosure. Further, the identification of a “first” element, does not necessarily require the presence of a “second” element. As used herein, the term “and/or” includes any and all combinations of one or more of the associated listed items.

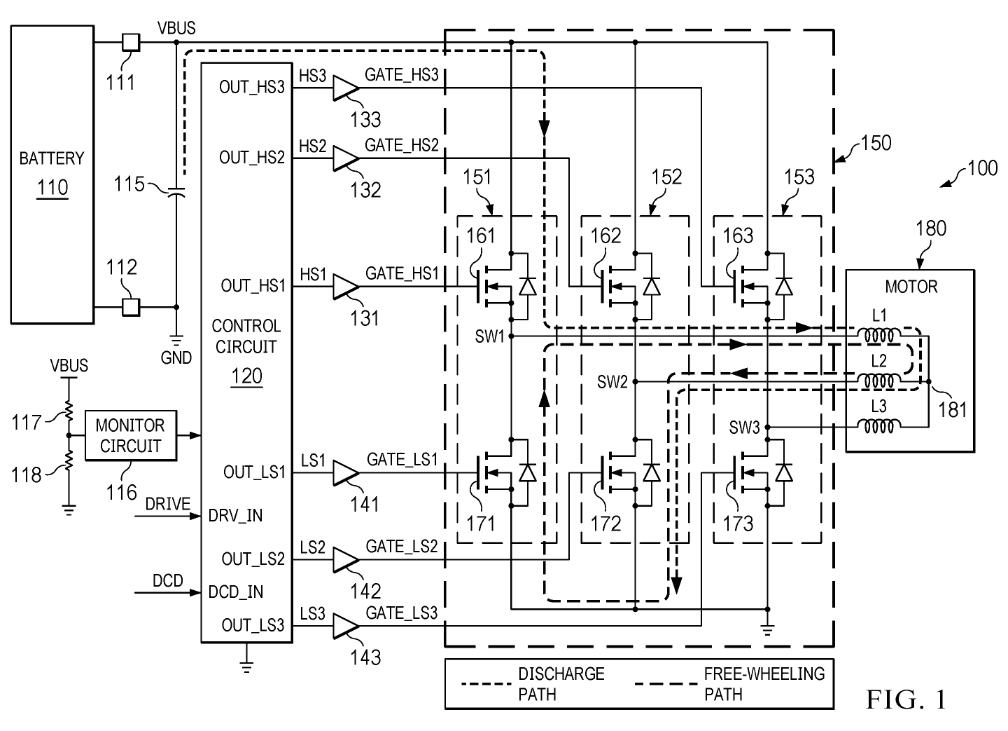

FIG. 1 illustrates a schematic diagram of motor drive system 100 in accordance with embodiments of the present disclosure. Motor drive system 100 may be implemented in any suitable fashion according to the operation described herein. In some embodiments, motor drive system 100 may include battery 110, contacts 111 and 112, DC link capacitor 115, monitor circuit 116, control circuit 120, high-side gate drivers 131-133, low-side gate drivers 141-143, inverter 150, and motor 180.

Motor drive system 100 may be powered by battery 110. Battery 110 may be a high-voltage battery that may be configured to provide power to inverter 150 and ultimately to motor 180 to generate the motive force for an electric vehicle for example. Battery 110 may be configured to operate at 400 V or 800 V for example. During operation of the electric vehicle, contacts 111 and 112 may be operated in a closed state in order to couple battery 110 across the DC voltage bus VBUS and the system ground GND. DC link capacitor 115 may be coupled to the DC voltage bus VBUS. Specifically, DC link capacitor 115 may be coupled across the DC voltage bus VBUS and the system ground GND. DC link capacitor 115 may be a large energy storage capacitor that may smooth any transient ripples that would otherwise occur on VBUS, for example, due to the switching of inverter 150. In some embodiments, DC link capacitor 115 may have a large capacitance in the range of 200 µF, 500 µF, 1000 µF, 1500 µF, or more.

Motor 180 may in some embodiments be a three-phase electrical motor. For example, motor 180 may include a first winding L1, a second winding L2, and a third winding L3. As shown in FIG. 1, each of first winding L1, second winding L2, and third winding L3 may have a first terminal coupled to be driven by a respective phase of inverter 150 and a second terminal coupled to a common node 181.

Inverter 150 may be coupled to the DC voltage bus VBUS. Specifically, inverter 150 may be coupled between the DC voltage bus VBUS and the system ground GND, and may thus draw power from the DC voltage bus VBUS to drive motor 180. In some embodiments, inverter 150 may be a three-phase inverter. For example, inverter 150 may include a first phase 151 coupled to the first winding L1 of motor 180 at switching node SW1, a second phase 152 coupled to the second winding L2 of motor 180 at switching node SW2, and a third phase 153 coupled to the third winding L3 of motor 180 at switching node SW3.

As shown in FIG. 1, first phase 151 may include high-side switch 161 coupled between VBUS and SW1, and low-side switch 171 coupled between SW1 and GND. Second phase 152 may include high-side switch 162 coupled between VBUS and SW2, and low-side switch 172 coupled between SW2 and GND. Further, third phase 153 may include high-side switch 163 coupled between VBUS and SW3, and low-side switch 173 coupled between SW3 and GND.

As depicted in FIG. 1, high-side switches 161-163 and low-side switches 171-173 may each be implemented in some embodiments as n-type metal-oxide semiconductor field-effect transistors (n-type MOSFETs or NMOS transistors). In some embodiments, high-side switches 161-163 and low-side switches 171-173 may be NMOS transistors formed with a silicon carbide (SiC) semiconductor material. In other embodiments, high-side switches 161-163 and low-side switches 171-173 may be formed with other semiconductor materials, such as silicon (Si) or any other semiconductor material suitable for the high-power and high-voltage operation of inverter 150. Although FIG. 1 illustrates an embodiment where high-side switches 161-163 and low-side switches 171-173 are implemented as NMOS transistors, high-side switches 161-163 and low-side switches 171-173 may also be implemented with any other suitable transistor type. For example, high-side switches 161-163 and low-side switches 171-173 may also be implemented as insulated gate bipolar transistors (IGBTs) formed for example with silicon (Si) or silicon carbide (SiC), or any other semiconductor material suitable for the high-power and high-voltage operation of inverter 150. In some embodiments, high-side switches 161-163 and low-side switches 171-173 may each be formed on their own semiconductor die and separately packaged as discrete transistors. In other embodiments, high-side switches 161-163 and low-side switches 171-173 may be formed either on the same semiconductor die or on separate semiconductor dies, and co-packaged together in a single-die or multi-die power module package.

Control circuit 120 may be implemented in any suitable fashion according to the operation described herein. Control circuit 120 may be implemented with software, digital circuitry, analog circuitry, or any suitable combination thereof. For example, in some embodiments, control circuit 120 may be implemented with a microcontroller unit (MCU) including a digital core, software, memory, and any suitable analog peripherals for interfacing with other components of motor drive system 100.

As shown in FIG. 1, control circuit 120 may be coupled to control inverter 150. For example, control circuit may include a plurality of outputs (OUT_HS1, OUT_HS2, OUT_HS3, OUT_LS1, OUT_LS2, and OUT_LS3) configured to control the switching of inverter 150, which may in turn be coupled to drive motor 180. For example, OUT_HS1 may be configured to drive high-side switch 161 via high-side gate driver 131, and OUT_LS1 may be configured to drive low-side switch 171 via low-side gate driver 141. Similarly, OUT_HS2 may be configured to drive high-side switch 162 via high-side gate driver 132, and OUT_LS2 may be configured to drive low-side switch 172 via low-side gate driver 142. Further, OUT_HS3 may be configured to drive high-side switch 163 via high-side gate driver 133, and OUT_LS3 may be configured to drive low-side switch 173 via low-side gate driver 143.

As shown in FIG. 1, high-side gate drivers 131-133 may translate the high-side control signals HS1, HS2, and HS3 from control circuit 120 into high-side gate drive signals GATE_HS1, GATE_HS2, and GATE_HS3 suitable to directly drive the respective gates of the high-side switches 161-163. For example, high-side gate drivers 131-133 may include level-shifting circuitry and buffer circuits suitable to directly drive the gates of high-side switches 161-163 to turn those switches on and off at high speeds. Similarly, low-side gate drivers 141-143 may translate the low-side control signals LS1, LS2, and LS3 from control circuit 120 into low-side gate drive signals GATE_LS1, GATE_LS2, and GATE_LS3 suitable to directly drive the respective gates of the low-side switches 171-173. For example, low-side gate drivers 141-143 may include level-shifting circuitry and buffer circuits suitable to directly drive the gates of low-side switches 171-173 to turn those switches on and off at high speeds. In some embodiments, high-side gate drivers 131-133 and low-side gate drivers 141-143 may be implemented as separate circuits from control circuit 120 as shown in FIG. 1. In other embodiments, high-side gate drivers 131-133 and low-side gate drivers 141-143 may be directly incorporated within control circuit 120. Because high-side gate drivers 131-133 and low-side gate drivers 141-143 translate the control signals from control circuit 120 to gate drive signals applied to the gates of high-side switches 161-163 and low-side switches 171-173, those high-side switches 161-163 and low-side switches 171-173 may be referred to, for the purposes of the present disclosure, as being driven by either of control circuit 120 or by the respective high-side gate drivers 131-133 and low-side gate drivers 141-143.

Control circuit 120 may include a drive input DRV_IN. During operation of the electric vehicle in which motor drive system 100 is implemented, control circuit 120 may receive a drive signal DRIVE that may instruct control circuit 120 how to drive inverter 150 (and thus ultimately motor 180) to provide the required motive force for the electric vehicle. In response to certain conditions, motor drive system 100 may be powered down. For example, when the electric vehicle is turned off, or in the event of a detected crash, contacts 111 and 112 may be forced to an open state to isolate the DC voltage bus VBUS and system ground GND from battery 110. As described in further detail below, control circuit 120 may also receive a discharge command DCD to initiate a controlled discharge of DC link capacitor 115. Such discharge may improve safety by removing the high-voltage present on VBUS when the electric vehicle is turned off.

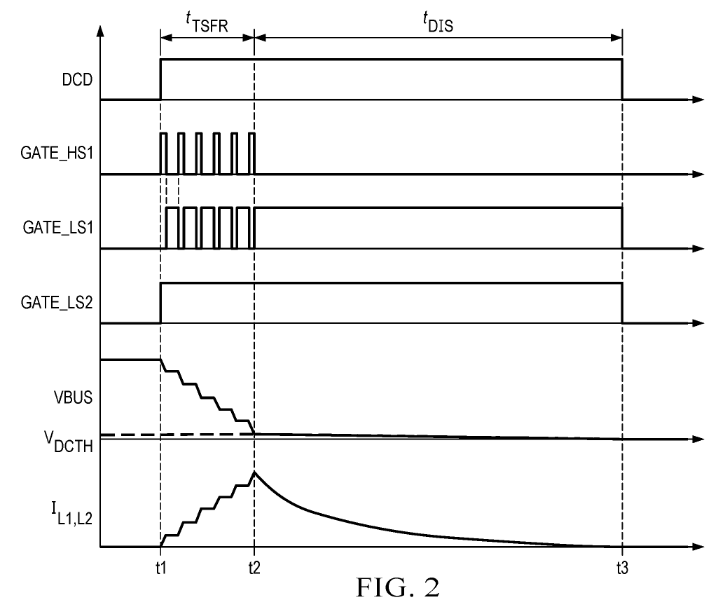

As shown in FIG. 1, control circuit 120 may include an input DCD_IN configured to receive a discharge command DCD. As described in further detail below, control circuit 120 may drive specific switches of inverter 150 in a pattern to first transfer energy stored as a voltage on DC link capacitor 115 to magnetic flux stored by windings for motor 180, and then to discharge that energy from the windings of motor 180. FIG. 2 illustrates plot diagrams of waveforms within motor drive system 100 during these energy transfer and discharge phases.

In response to a discharge command DCD, control circuit 120 may drive the high-side switch 161 of first phase 151 of inverter 150 with a high-side PWM signal, and may drive the low-side switch 172 of second phase 152 of inverter 150 in an on-state. For example, as shown in FIG. 2, in response to the logic-high level of the discharge command DCD at time t1, control circuit 120 may drive (via high-side gate driver 131) the gate of high-side switch 161 (GATE_HS1) with a high-side PWM signal to repeatedly turn on and off high-side switch 161 during a transfer period t_{TSFR} spanning from timet1 to time t2. In some embodiments, the high-side PWM signal may have a fixed pulse width. Such a fixed pulse width may in some embodiments be programmable, and thus may be set by system level designers based on certain parameters such as the voltage and capacitance of DC link capacitor 115 and any safety requirements specifying how fast the voltage of DC link capacitor 115 must be decreased after motor drive system 100 is powered down.

During this transfer period t_{TSFR}, control circuit 120 may also drive the low-side switch 171 of first phase 151 of inverter 150 with a low-side PWM signal that is the inverse of the high-side PWM signal. For example, as shown in FIG. 2, in response to the logic-high level of the discharge command DCD at time t1, control circuit 120 may drive (via low-side gate driver 141) the gate of low-side switch 171 (GATE_LS1) with a low-side PWM signal to repeatedly turn on and off low-side switch 171 during the transfer period t_{TSFR} spanning from time t1 to time t2. As also shown in FIG. 2, the low-side PWM signal driven the gate of low-side switch 171 (GATE_LS1) may be the inverse of the high-side PWM signal driving the gate of high-side switch 161 (GATE_HS1). Thus, high-side switch 161 and low-side switching 162 may turn on and off in alternating fashion from each other during the transfer period t_{TSFR} spanning from time t1 to time t2. In some embodiments, the high-side PWM signal and the low-side PWM signal respectively driving high-side switch 161 and low-side switch 171 may be configured to be non-overlapping to prevent high and uncontrolled shoot-through currents that may otherwise occur if high-side switch 161 and low-side switch 171 were both held in an on-state at the same time.

By turning high-side switch 161 and low-side switch 171 on and off in an alternating manner relative to each other, and by holding low-side switch 172 in an on-state, control circuit 120 effectively uses the first winding L1 and second winding L2 of a motor 180 as the inductance of a buck converter with the output shorted to system ground GND. For example, when high-side switch 161 is in an on-state, low-side switch 171 is in an off-state, and low-side switch 172 is in an on-state, a discharge path may be formed from DC link capacitor 115, through high-side switch 161, through first winding L1 and second winding L2 of motor 180, and through low-side switch 172 to system ground GND. During this first PWM state, current may flow from DC link capacitor 115 to system ground GND via the discharge path, thereby reducing the voltage held by DC link capacitor 115 on the DC voltage bus VBUS. Further, the value of the current may rise as the magnetic flux stored by the inductance of first winding L1 and second winding L2 increases. Accordingly, the energy stored as a voltage by DC link capacitor 115 on DC voltage bus VBUS may be transferred to a magnetic flux stored by the first winding L1 and second winding L2.

Conversely, when high-side switch 161 is in an off-state, low-side switch 171 is in an on-state, and low-side switch 172 is in an on-state, a free-wheeling path may be formed as shown in FIG. 1. During this second PWM state, the free-wheeling path may allow current to recirculate from system ground GND, through low-side switch 171, through first winding L1 and second winding L2, and through low-side switch 172. The resistive voltage drop due to the current through low-side switch 172 and low-side switch 171 may provide for a small negative voltage across the first winding L1 and second winding L2. This negative voltage may cause the recirculation current through the free-wheeling path to decrease at a rate proportional to the negative voltage drop during the second PWM state.

Although low-side switch 171 is described above as being driven by the low-side PWM signal during the transfer period t_{TSFR}, low-side switch 171 may in some embodiments be held in an off-state during the transfer period t_{TSFR}. For such embodiments, the recirculation current of the free-wheeling path may flow through the body diode of low-side switch 171 during the second PWM state instead of through the MOSFET channel of low-side switch 171. The additional voltage drop caused by the current flowing through the body diode instead of the MOSFET channel of low-side switch 171 may provide an additional negative voltage drop across the first winding L1 and second winding L2, thereby causing the recirculation current through the free-wheeling path to decrease at a faster rate during the second PWM state.

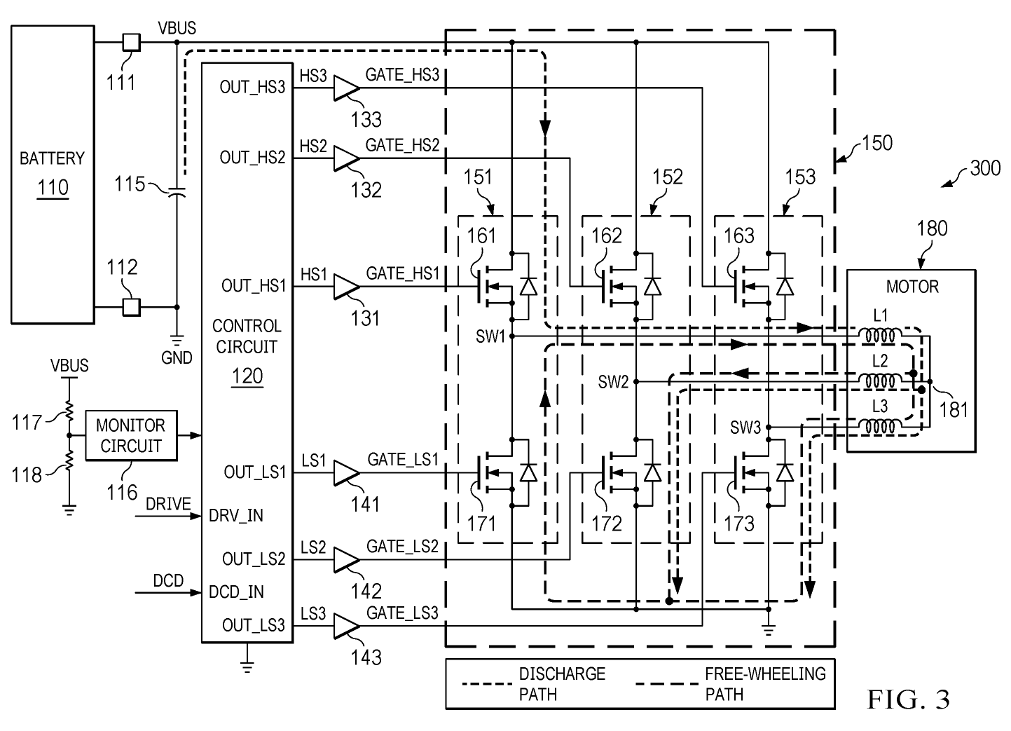

Subsequent to the transfer period t_{TSFR} spanning from time t1 to time t2, control circuit 120 may drive high-side switch 161 of first phase 151 in an off-state, and drive low-side switch 172 of second phase 152 of inverter 150 in an on-state for a discharge period t_{DIS} spanning from time t2 to the time t3. During this discharge period t_{DIS}, control circuit 120 may also optionally drive low-side switch 171 in an on-state. The resistive voltage drop due to the current through low-side switch 172 and low-side switch 171 may provide for a small negative voltage drop across the first winding L1 and second winding L2. This negative voltage may cause the recirculation current through the free-wheeling path to decrease at a rate proportional to the negative voltage drop. As shown in FIG. 3, the discharge period t_{DIS} may be designed with a long enough time interval to allow the recirculation current through the free-wheeling path to dissipate to zero.

Although low-side switch 171 is described above as being driven in an on-state during the discharge period t_{DIS} spanning from time t2 to time t3, low-side switch 171 may in some embodiments be held in an off-state during the discharge period t_{DIS}. For such embodiments, the recirculation current of the free-wheeling path may flow through the body diode instead of through the MOSFET channel of low-side switch 171. The additional voltage drop caused by the current flowing through the body diode instead of the MOSFET channel of low-side switch 171 may provide an additional negative voltage drop across the first winding L1 and second winding L2, thereby causing the recirculation current through the free-wheeling path to decrease at a faster rate.

The larger voltage drop across the body diode instead of the MOSFET channel of low-side switch 171 may provide a faster discharge of the magnetic flux stored in first winding L1 and second winding L2 during the discharge period t_{DIS}, but at the expense of more heat generation. Thus, system level designers may choose to drive low-side switch 171 in either an on-state or an off-state during the discharge period t_{DIS} based on a balance of timing and thermal considerations. In some embodiments, the option to drive low-side switch 171 in either an on-state or an off-state during the discharge period t_{DIS} may be programmable, for example based on a programmable memory or register in control circuit 120. In some embodiments, the option to drive low-side switch 171 with the low-side PWM signal or alternatively in an off-state during the transfer period t_{TSFR} may be similarly programmable.

In some embodiments, control circuit 120 may be configured to transition from the transfer period t_{TSFR} to the discharge period t_{DIS} in response to expiration of a predetermined time for the transfer period t_{TSFR}. The predetermined time may be set to be long enough to allow the voltage of DC link capacitor 115 on the DC voltage bus VBUS to decrease below a voltage threshold V_{DCTH}. In some embodiments, the predetermined time may be programmable to allow system-level designers flexibility in setting the transfer period t_{TSFR} based, for example, on the voltage level of VBUS during operation and the capacitance of DC link capacitor 115.

In other embodiments, control circuit 120 may be configured to transition from the transfer period t_{TSFR} to the discharge period t_{DIS} in response to a monitor circuit detecting that the voltage of DC link capacitor 115 has crossed below a voltage threshold V_{DCTH}. For example, as shown in FIG. 1, resistors 117 and 118 may form a voltage divider configured to output a voltage signal proportional to VBUS. Monitor circuit 116 may monitor the voltage signal proportional to VBUS, and may signal control circuit when VBUS crosses below the voltage threshold V_{DCTH}. In some embodiments, the voltage threshold V_{DCTH} may be, for example, 60 V. In response to monitor circuit 116, control circuit 120 may then transition from the drive pattern of the transfer period t_{TSFR} to that of discharge period t_{DIS}.

The pulse-width modulation scheme described herein may have multiple advantages over systems that merely turn on a discharge path through one or more transistors of the inverter circuit. For example, by driving high-side switch 161 with a high-side PWM signal and low-side switch 172 in an on-state during the transfer period t_{TSFR}, control circuit 120 may provide for a discharge of the DC link capacitor 115 on the DC voltage bus VBUS at a controlled rate during the transfer period t_{TSFR} while the current through first winding L1 and second winding L2 rises. Further, pulse-width modulating high-side switch 161 during the transfer period t_{TSFR} as opposed to driving high-side switch 161 in a continuous on-state may spread out the thermal stress endured by high-side switch 161 over a longer time period, thereby reducing the thermal strain on the device during the transfer period t_{TSFR}.

Motor 180 may be configured such that a minimum drive current applied by each of the three phases of inverter 150 to the respective windings L1, L2, and L3 of motor 180 is required to induce motive force in motor 180 during operation of the electric vehicle. The peak current through any winding of motor 180 during the transfer period t_{TSFR} may be less than the minimum drive current required to induce motive force in motor 180. Moreover, the discharge current through the first winding L1 and the second winding L2 (FIG. 1), or through the first winding L1 and split between the second winding L2 and third winding L3 (FIG. 3), will flow simultaneously during the transfer period t_{TSFR} instead of at three equally spaced phases as applied to motor 180 by inverter 150 during normal operation of the electric vehicle. Further, the recirculation current flowing through the windings in the free-wheeling path during the discharge period t_{DIS} will likewise flow through the windings simultaneously instead of at three equally spaced phases. Accordingly, motor drive system 100 may utilize the windings of motor 180 to help discharge DC link capacitor 115 on the DC voltage bus VBUS without creating any unwanted motive force in motor 180 while the motor drive system 100 is powered down.

FIG. 3 illustrates a schematic diagram of motor drive system 300 in accordance with embodiments of the present disclosure. Motor drive system 300 may be implemented in any suitable fashion according to the operation described herein. In some embodiments, motor drive system 300 may include battery 110, contacts 111 and 112, DC link capacitor 115, monitor circuit 116, control circuit 120, high-side gate drivers 131-133, low-side gate drivers 141-143, inverter 150, and motor 180, each of which may be implemented and operate in a similar manner as described above for motor drive system 100 of FIG. 1.

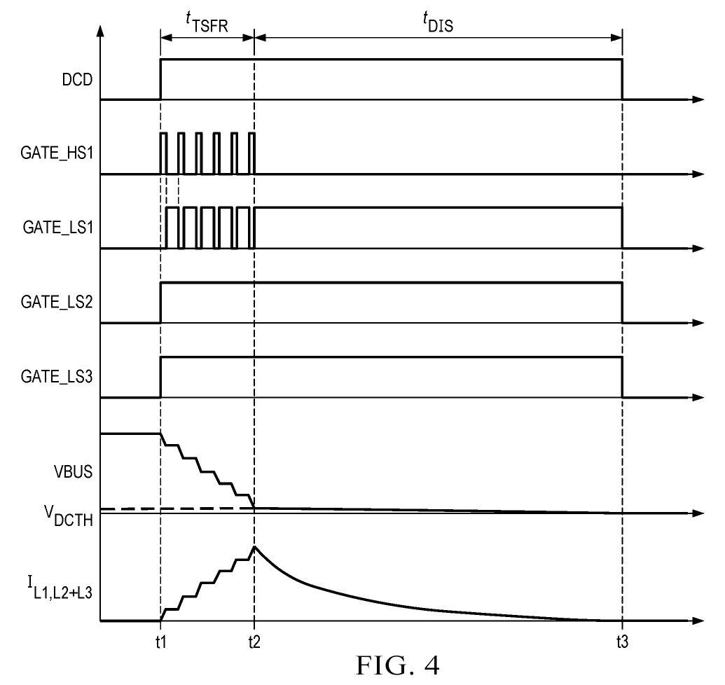

In addition, the embodiment of control circuit 120 in motor drive system 300 may be further configured to drive low-side switch 173 of third phase 153 of inverter 150 in an on-state during the transfer period t_{TSFR} and during the discharge period t_{DIS}. For example, as shown in FIG. 4, the gate of low-side switch 173 (GATE_LS3) may be held high in a similar manner as the gate of low-side switch 172 (GATE_LS2) during the transfer period t_{TSFR} and during the discharge period t_{DIS}. Accordingly, referring back to FIG. 3, the discharge path formed during the first PWM state (described above with reference to FIG. 1) may include two parallel branches, including a first branch through second winding L2 and low-side switch 172 of second phase 152, and a second branch through third winding L3 and low-side switch 173 of third phase 153. Similarly, the free-wheeling path formed during the second PWM state (described above with reference to FIG. 1) of the transfer period t_{TSFR}, and also during the discharge period t_{DIS}, may include two parallel branches, including a first branch through second winding L2 and low-side switch 172 of second phase 152, and a second branch through third winding L3 and low-side switch 173 of third phase 153.

By utilizing a parallel branches, the current that would otherwise flow through second winding L2 may be split between second winding L2 and third winding L3. Likewise, the current that would otherwise flow through low-side switch 172 may be split between low-side switch 172 and low-side switch 173. Accordingly, the electrical and thermal strain that would otherwise be endured by low-side switch 172 during the transfer period t_{TSFR} and the discharge period t_{DIS} may be reduced.

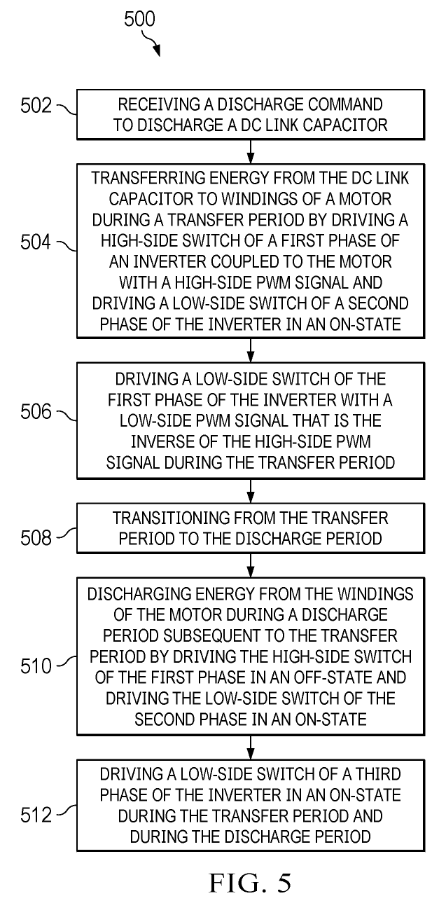

FIG. 5 illustrates a method for controlling operation of a motor drive system in accordance with embodiments of the present disclosure. Method 500 may be performed by any suitable mechanism, such as control circuit 120 alone or in combination with other elements of motor drive system 100 and motor drive system 300. Method 500 may be performed with fewer or more steps than shown in FIG. 5. Moreover, steps of method 500 may be omitted, repeated, performed in parallel, performed in a different order than shown in FIG. 5, or performed recursively. As one example, step 506 and/or step 512 may be omitted. One or more steps of method 500, although shown in an order, may be performed at the same time or in a re-ordered manner. As one example, step 506 may be optional and may be performed at the same time as step 504. As another example, step 512 may be performed at the same time as steps 504-510.

Step 502 may include receiving a discharge command to discharge a DC link capacitor. For example, as described above with reference to FIG. 1, control circuit 120 may receive a discharge command DCD that instructs control circuit 120 to control the discharge of DC link capacitor 115.

Step 504 may include transferring energy from the DC link capacitor to windings of a motor during a transfer period by driving a high-side switch of a first phase of an inverter coupled to the motor with a high-side PWM signal and driving a low-side switch of a second phase of the inverter in an on-state. For example, as described above with reference to FIGS. 1 and 2, control circuit 120 may drive (via high-side gate driver 131) the high-side switch 161 of first phase 151 of inverter 150 with a high-side PWM signal during the transfer period t_{TSFR}. Control circuit 120 may also drive (via low-side gate driver 142) the low-side switch 172 of second phase 152 of inverter 150 in an on-state. By turning high-side switch 161 on an off, and by holding low-side switch 172 in an on-state during the transfer period t_{TSFR}, control circuit 120 effectively uses the first winding L1 and second winding L2 of a motor 180 as the inductance of a buck converter with the output shorted to system ground GND. Accordingly, the energy stored as a voltage by DC link capacitor 115 on DC voltage bus VBUS may be transferred to a magnetic flux stored by the first winding L1 and second winding L2 during the transfer period t_{TSFR}.

Step 506 may include driving a low-side switch of the first phase of the inverter with a low-side PWM signal that is the inverse of the high-side PWM signal during the transfer period. For example, as described above with reference to FIG. 1, control circuit 120 may optionally drive (via low-side gate driver 141) low-side switch 171 of first phase 151 of inverter 150 with a low-side PWM signal during the transfer period t_{TSFR}. The low-side PWM signal that drives low-side switch 171 may be the inverse of the high-side PWM signal that drives high-side switch 161 in order to turn on and off high-side switch 161 and low-side switch 171 in an alternating fashion relative to each other.

Step 508 may include transitioning from the transfer period to the discharge period. For example, as described above with reference to FIGS. 1 and 2, control circuit 120 may in some embodiments transition from the transfer period t_{TSFR} to the discharge period t_{DIS} in response to the expiration of a predetermined time for the transfer period t_{TSFR} (spanning from time t1 to time t2 in FIG. 2). As also described above with reference to FIG. 2, control circuit 120 may in other embodiments transition from the transfer period t_{TSFR} to the discharge period t_{DIS} in response to monitor circuit 116 detecting that a voltage of the DC link capacitor has crossed below the voltage threshold V_{DCTH}.

Step 510 may include discharging energy from the windings of the motor during a discharge period subsequent to the transfer period by driving the high-side switch of the first phase in an off-state and driving the low-side switch of the second phase in an on-state. For example, as described above with reference to FIGS. 1 and 2, control circuit 120 may control the discharging of energy from the windings of motor 180 during a discharge period discharge period t_{DIS} subsequent to the transfer period t_{TSFR} to by driving the low-side switch 172 of second phase 152 in an on-state while driving the high-side switch 161 of first phase 151 in an off-state. During this discharge period t_{DIS}, the recirculation current through the free-wheeling path may decrease at a rate proportional to the voltage drop across low-side switch 172 and low-side switch 171, thereby causing the magnetic flux in windings L1 and L2 of motor 180 to discharge.

Step 512 may include driving a low-side switch of a third phase of the inverter in an on-state during the transfer period and during the discharge period. For example, as described above with reference to FIGS. 3 and 4, control circuit 120 may drive (via low-side gate driver 143) the low-side switch 173 of third phase 153 of inverter 150 in an on-state similar to the low-side switch 172 of second phase 152 of inverter. By creating a parallel current path through both low-side switch 172 and low-side switch 173, the electrical and thermal strain that would otherwise be endured by low-side switch 172 during the transfer period t_{TSFR} and the discharge period t_{DIS} may be reduced.

Although examples have been described above, other modifications and variations may be made from this disclosure without departing from the spirit and scope of these examples. The above descriptions of various embodiments illustrate the principles of the invention. Numerous variations and modifications will become apparent to those skilled in the art based on the above disclosure. The following claims are intended to embrace all such variations and modifications.

1. A method of controlling operation of a motor drive system, comprising:
transferring energy from a DC link capacitor to windings of a motor during a transfer period by driving a high-side switch of a first phase of an inverter coupled to the motor with a high-side PWM signal and driving a low-side switch of a second phase of the inverter in an on-state; and
discharging energy from the windings of the motor during a discharge period subsequent to the transfer period by driving the high-side switch of the first phase in an off-state and driving the low-side switch of the second phase in an on-state.

2. The method of claim 1, further comprising transitioning from the transfer period to the discharge period in response to detecting that a voltage of the DC link capacitor has crossed below a voltage threshold.

3. The method of claim 1, further comprising transitioning from the transfer period to the discharge period in response to expiration of a predetermined time for the transfer period.

4. The method of claim 1, further comprising driving a low-side switch of the first phase of the inverter with a low-side PWM signal that is an inverse of the high-side PWM signal during the transfer period.

5. The method of claim 1, further comprising driving a low-side switch of a third phase of the inverter in an on-state during the transfer period and during the discharge period.

6. The method of claim 1, wherein the high-side PWM signal has a fixed pulse width.

7. The method of claim 1, wherein a peak current through the windings of the motor during the transfer period is insufficient for inducing motive force in the motor.

8. A motor drive system comprising:
a DC link capacitor coupled to a DC voltage bus;
a motor including a first winding, a second winding, and third winding;
an inverter coupled to the DC voltage bus and including:
a first phase coupled to the first winding of the motor;
a second phase coupled to the second winding of the motor; and
a third phase coupled to the third winding of the motor;
a control circuit coupled to control the inverter, wherein control circuit is configured to:
drive a high-side switch of the first phase of the inverter with a high-side PWM signal and drive a low-side switch of the second phase of the inverter in an on-state for a transfer period; and
subsequent to the transfer period, drive the high-side switch of the first phase in an off-state and drive the low-side switch of the second phase in an on-state for a discharge period.

9. The motor drive system of claim 8, wherein the control circuit is configured to transition from the transfer period to the discharge period in response to a monitor circuit detecting that a voltage of the DC link capacitor has crossed below a voltage threshold.

10. The motor drive system of claim 8, wherein the control circuit is configured to transition from the transfer period to the discharge period in response to expiration of a predetermined time for the transfer period.

11. The motor drive system of claim 8, wherein the control circuit is further configured to drive a low-side switch of the first phase of the inverter with a low-side PWM signal that is an inverse of the high-side PWM signal during the transfer period.

12. The motor drive system of claim 8, wherein the control circuit is further configured to drive a low-side switch of the third phase of the inverter in an on-state during the transfer period and during the discharge period.

13. The motor drive system of claim 8, wherein the high-side PWM signal and a duration of the transfer period are configured such that a peak current through any winding of the motor is insufficient for inducing motive force.

14. A control circuit for a motor drive system comprising:
an input configured to receive a discharge command; and
a plurality of outputs configured to control switching of an inverter that is to be powered by a DC voltage bus and coupled to a motor; and
wherein the control circuit is configured to:
in response to the discharge command, drive a high-side switch of a first phase of the inverter with a high-side PWM signal and drive a low-side switch of a second phase of the inverter in an on-state for a transfer period; and
subsequent to the transfer period, drive the high-side switch of the first phase in an off-state and drive the low-side switch of the second phase in an on-state for a discharge period.

15. The control circuit of claim 14, wherein the control circuit is configured to transition from the transfer period to the discharge period in response to a monitor circuit detecting that the DC voltage bus has crossed below a voltage threshold.

16. The control circuit of claim 14, wherein the control circuit is configured to transition from the transfer period to the discharge period in response to expiration of a predetermined time for the transfer period.

17. The control circuit of claim 14, wherein the control circuit is further configured to drive a low-side switch of the first phase of the inverter with a low-side PWM signal that is an inverse of the high-side PWM signal during the transfer period.

18. The control circuit of claim 14, wherein the control circuit is further configured to drive a low-side switch of a third phase of the inverter in an on-state during the transfer period and during the discharge period.

19. The control circuit of claim 14, wherein the high-side PWM signal and a duration of the transfer period are configured such that a peak current through any winding of the motor is insufficient for inducing motive force.

20. The control circuit of claim 14, wherein the high-side PWM signal has a fixed pulse width.
